(19) United States
(12) Patent Application Publication
(10) Pub. No.: US 2012/0015136 A1
(43) Pub. Date: Jan. 19, 2012

(54) Arms and Knees Sun Protector

(76) Inventors: Vladimir Ziserson, Wheeling, IL (US); Roman Liufa, Wheeling, IL (US)

(21) Appl. No.: 13/186,045

(22) Filed: Jul. 19, 2011

Related U.S. Application Data
(60) Provisional application No. 61/365,494, filed on Jul. 19, 2010.

(51) Int. Cl. B32B 3/02

(52) U.S. Cl. 428/80

(57) ABSTRACT

A cape having a UPF of at least ten for protecting a driver of an automobile from harmful ultraviolet rays of the sun. The cape has a main portion with an upper end and a lower end. The upper end includes a neck opening sized to receive a neck of an automobile driver, and the main portion is sized to drape over the shoulders and front torso of an automobile driver. A first and a second arm extension portion extend from the main portion, and each arm extension is sized to drape over an arm of an automobile driver.

### REFERENCE TO RELATED APPLICATION

This non-provisional patent application claims priority to U.S. provisional patent application entitled “Arms and Knees Sun Protector,” having application No. 61/365,494, and filed on Jul. 19, 2010, the entire contents of which are hereby incorporated by reference.

### BACKGROUND OF THE INVENTION

1. Field of the Invention

The present invention relates generally to sun protection devices, and more particularly, to a garment for a protecting a person's arms and knees from harmful ultraviolet radiation from the sun while driving an automobile.

2. Description of Related Art

The harmful effects of ultraviolet radiation from the sun upon a person's skin are becoming more of a concern in the past few years. Sun exposure causes most of the skin changes that people believe are a normal part of aging. Over time, the sun's ultraviolet (UV) light damages the fibers in the skin called elastin. When these fibers breakdown, the skin begins to sag, stretch, and lose its ability to go back into place after stretching. Skin cancer is the most prevalent form of all cancers in the United States and the number of cases continues to rise.

Cancer involves the uncontrolled growth of abnormal skin cells. This rapid growth results in tumors, which are either benign (noncancerous) or malignant (cancerous). There are three main types of skin cancer: (1) basal cell carcinoma, (2) squamous cell carcinoma and (3) melanoma. Basal cell and squamous cell cancers are less serious types and make up 95% of all skin cancers. Also referred to as non-melanoma skin cancers, these cancers are curable when treated early. However, melanoma, made up of abnormal skin pigment cells called melanocytes, is the most serious form of skin cancer and causes 75% of all skin cancer deaths. Left untreated, melanoma can spread to other organs and is difficult to control.

Ultraviolet (UV) radiation from the sun is the number one cause of skin cancer. Exposure to sunlight during the winter months puts a person at the same risk as exposure during the summertime. Cumulative sun exposure causes mainly basal cell and squamous cell skin cancer, while episodes of severe sunburns, usually before age 18, can cause melanoma later in life. Other less common causes are repeated X-ray exposure and occupational exposure to certain chemicals.

New research suggests that people in the USA are more likely to develop skin cancer, including melanoma and merkel cell carcinoma, on the left side of their bodies. Driving may be to blame because the left arm receives more ultraviolet radiation according to reseachers from the University of Washington in Seattle, who analyzed cancer cases recorded in a government database. The researchers found that when skin cancer occurs on one side of the body, 52 percent of melanoma cases and 53 percent of merkel cell carcinomas were on the left side. On the upper arms, 55 percent of merkel cell cases developed on the left side. The National Cancer Insitute states that more than 68,000 people were diagnosed with melanoma in 2010, and 8,700 people died from it.

Other research supports the idea that sun exposure while driving can contribute to cancer. In countries where people drive on the opposite side of the road, the right arm gets more sun. Researchers cited a 1986 study that found Australian men were more likely to get precancerous growths on their right sides.

Accordingly, there is a need for a garment that can protect the exposed skin of automobile driver from harmful ultraviolet radiation from the sun.

### SUMMARY OF THE INVENTION

In accordance with the present invention, a cape is provided having a UPF of at least ten for protecting a driver of an automobile from harmful ultraviolet rays of the sun. A main portion of the cape has an upper end and a lower end, wherein the upper end includes a neck opening sized to receive a neck of an automobile driver, and the main portion is sized to drape over the shoulders and the front torso of an automobile driver. A first and a second arm extension portion extend from the main portion, and each arm extension is sized to drape over an arm of an automobile driver. Velcro® attached to the distal end of each arm extension functions as a wrist connector for securing the distal end of an arm extension to a wrist of a driver.

A lap extension for covering the lap and knees of an automobile driver can be connected to the lower end of the main portion of the cape. The lap extension can be part of the main portion or attached as an additional piece by buttons or Velcro®.

The foregoing has outlined, rather broadly, the preferred features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiments as a basis for designing or modifying other structures for carrying out the same purposes of the present invention and that such other structures do not depart from the spirit and scope of the invention in its broadest form.

### BRIEF DESCRIPTION OF THE DRAWINGS

FIG. 1 is a plan view of a sun protector configured in accordance with a first embodiment of present invention;

FIG. 2 is plan view of sun protector configured in accordance with a second embodiment of the present invention; and

FIG. 3. is a plan view of sun protector configured in accordance with a third embodiment of the present invention.

### DETAILED DESCRIPTION OF THE PREFERRED EMBODIMENTS

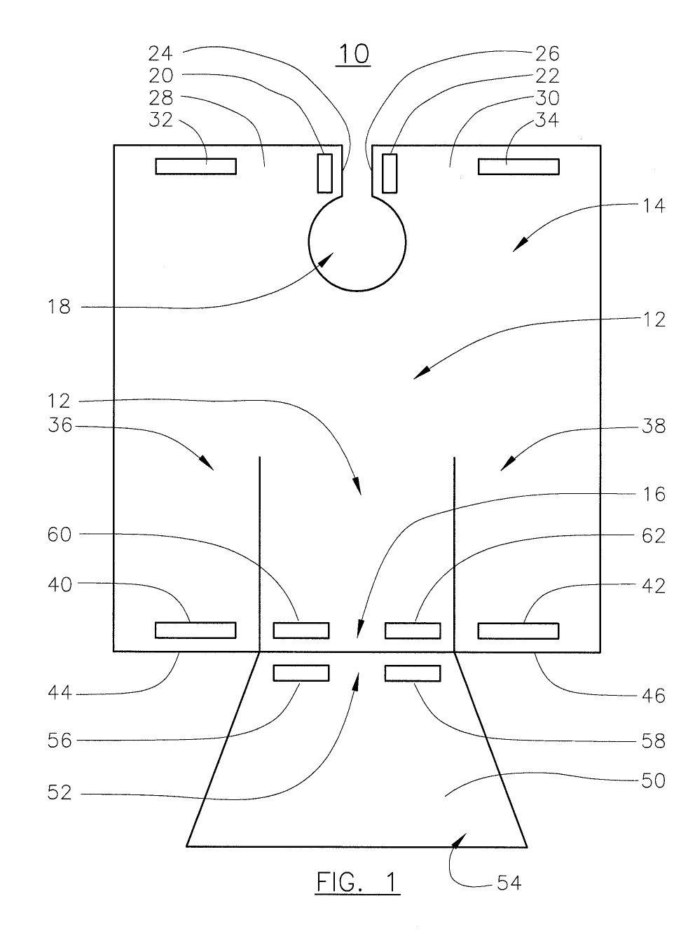

Referring now to the drawings, FIG. 1 is a plan view of a sheet of material 10 configured in accordance with a preferred embodiment of the present invention. The sheet of material 10, or cape, garment, or cut pattern of material, is constructed of material having an Ultraviolet Protection Fact (UPF) of at least 10. The sheet of material 10 preferably is worn over the shoulders and front torso of a driver of an automobile to protect the skin of the driver from harmful ultraviolet radiation from the sun.

Various materials can be used to construct the sheet of material 10. Preferably, dense, tight construction (either weaves or knits) minimizes the spaces between yarns, which in turn minimize the amount of Ultraviolet (UV) light that can pass through the material. Some tightly constructed UPF-rated garments use vents to boost air circulation and help the wearer stay cool. Thicker fabrics also help reduce UV transmission.

The type of dye also can affect the UV protection of material. The specific type of dye (and the concentration in which it is used) impacts a fabric's UV transmission, not its color. Some dyes deflect more UV radiation than others, and some absorb none at all, including black dyes. Clothing engineered for UV protection may use high concentrations of premium dyes that disrupt UV light. Such dyes include “conjugated” molecules that disrupt UV radiation. The higher the concentration of such dyes, the darker the garment becomes. But ultimately color has no influence on UV rays. Pigment-dyed fabrics, which include a resin that creates a powdery look and feel, get high marks for UV protection.

Chemicals effective at absorbing UV light may be added during processing to increase UV protection. Specialized laundry additives, which include optical brightening agents and newly developed UV-disrupting compounds, can boost a garment's UPF rating. Polyester does an excellent job at disrupting UV light (due to hydrogen- and carbon-based benzene rings within the polymer). Nylon is good. Wool and silk are moderately effective. Cotton, rayon, flax and hemp fabrics (natural fibers composed of cellulose polymers) often score low without added treatments. However, unbleached or naturally colored cotton performs better at interacting with UV light than bleached cotton.

If a garment is stretched 10% or more beyond its normal dimensions, spaces between yarns are widened and its effectiveness against UV light may be reduced up to 40%. Also, a fabric's ability to disrupt UV radiation is usually reduced when wet, though the reasons why are not completely understood. Wetness may cause a 30% to 50% reduction in a fabric's UPF rating. Furthermore, worn or faded fabrics are less effective against UV light.

In 1998, the American Association of Textile Chemists and Colorists (AATCC) adopted a UPF rating system for use in the United States. Shorty afterwards, the American Society for Testing and Materials (ASTM) expanded testing to include a garment's life cycle and for labeling a garment's sun-protectiveness. The AATCC test method is used to determine apparel and textiles protection levels. The method rates the amount of UVA and UVB that is blocked by a fabric. The amount of UV rays blocked or absorbed by a fabric is determined by a machine in a laboratory, and the rating is based on the ratio of UV protection of a fabric compared to protection without the fabric. For example, if a fabric or garment is rated UPF 30, it means that it is blocking or absorbing 29 out of 30 units of both UVA and UVB, or blocking 97% of all UV rays.

The cape 10 shown in FIG. 1 includes a main portion 12 having an upper end 14 and a lower end 16. The upper end 14 includes a neck opening 18 sized for receiving the neck of a driver of an automobile. Neck opening connectors 20,22 are located on tabs 24,26 of the neck opening 18 for securing the cape 10 around the neck of an automobile driver. Upper tabs 28,30 on the upper end 14 of the main portion 12 of the cape 10 include connectors 32,34 for connecting the upper end 14 of the cape 10 to the back of the shoulders of an automobile driver or the back of a seat of an automobile. The connector 32,34 are preferably strips of Velcro®, but also can be buttons, hooks, or other type of known fastener for clothing. Similarly, the connectors 20,22 for closing the opening 18 in the cape 10 around the neck of an automobile driver also are preferably strips of Velcro®, but also can be buttons, hooks, or other type of known fastener for clothing.

In accordance with the present invention, arm extensions are attached to the main portion 12 of the cape 10 for draping over the arms of an automobile driver. FIG. 1 illustrates a first arm extension 36 and a second arm extension 38 attached to the main portion 12 of the cape 10. A first wrist connector 40 is attached to a distal end 44 of the first arm extension 36. A second wrist connector 42 is attached to a distal end 46 of the second arm extension 38. The wrist connectors 40,42 function to position the distal ends 44,46 of the arm extension 36,38 around the wrist of an automobile driver. Similar to the connectors 20,22 and 32,34, the wrist connectors 40,42 are preferably strips of Velcro®, but also can be buttons, hooks, or other type of known fastener for clothing.

In accordance with a further aspect of the present invention, a lap extension 50 is connected to the lower end 16 of the main portion 12 of the cape 10. The lap extension 50 includes an upper end 52 and a lower end 54. The lap extension 50 functions to drape over the lap and knees of an automobile driver to protect an automobile driver's lap and knees from the ultraviolet radiation from the sun. The lap extension 50 can be a continuous piece of material from the main portion 12 of the cape 10, or a separate piece of material that is connected to the main portion 12 of the cape. In a multiple piece configuration, the upper end 52 of the lap extension 50 includes connectors 56,58 which are attached to connectors 60,62 on the lower end 16 of the main portion 12 of the cape 10. The connectors 56,58,60,62 can be Velcro®, buttons, zippers, or other known device for attaching clothing. The lap extension 50 is constructed of material that also has a UPF of at least 10. The lap extension 50 also can be configured to flare out at the lower end 54.

Of course, in other embodiments the cape 10 could be cut to cover only the left side of a driver of an automobile.

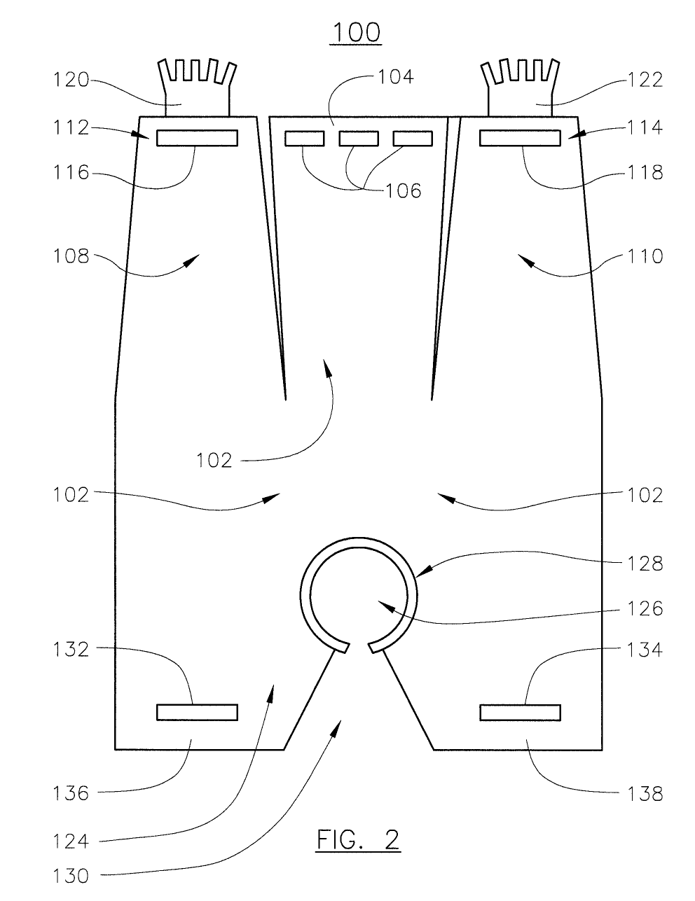

FIG. 2 illustrates a cape 100 configured in accordance with another embodiment of the present invention. The cape 100 includes a main portion 102. A lower end 104 of the main portion 102 includes connectors 106 for attaching a lap extension as shown in FIG. 1. First and second arm extensions 108,110 are connected to the main portion 102 of the cape 100 and preferably formed out of a single piece of material from the main portion 102 having a UFP of at least 10.

Distal ends 112,114 of the arm extensions 108,110, respectively, include wrist connectors 116,118 for positioning the distal ends 112,114 around the wrists of an automobile driver. The main portion 102 of the cape 100 is sized to drape over the front torso of an automobile driver. The arm extensions 108, 110 are sized to draped over the arms of an automobile driver, while being open underneath the arms of an automobile driver to provide air ventilation.

As an added feature, open-finger-ended gloves 120,122 having a UPF of at least 10 can be worn by an automobile driver in combination with the cape 10. The gloves 120,122 can be separated from or sewn into the distal ends 112,114 of the arm extensions 108,110. In the illustrated embodiment of FIG. 2, the arm extensions 108,110 taper inward toward the distal ends 112,114 of the arm extensions 108,110. This pattern enables the cape 10 be cut from a single piece of material, wherein the lower end 104 of the main portion 102 is cut to flare outward.

The upper end 124 of the main portion 102 of the cape 100 includes an opening 126 sized for receiving the neck of an automobile driver. A collar 128 encircles the opening 126 to provide a better seal around the neck of an automobile driver.

The upper end 124 of the cape 10 includes a cut-out 130 for more easily placing the opening 126 around the neck of an automobile driver. Connectors 132,134 are attached to upper tabs 136,138 on the upper end 124 of the main portion 102 of the cape 100. The connectors 132,134, preferably Velcro®, enable the upper end 124 of the cape 100 to be attached to the back shoulders of an automobile driver or the back of a seat of an automobile driver.

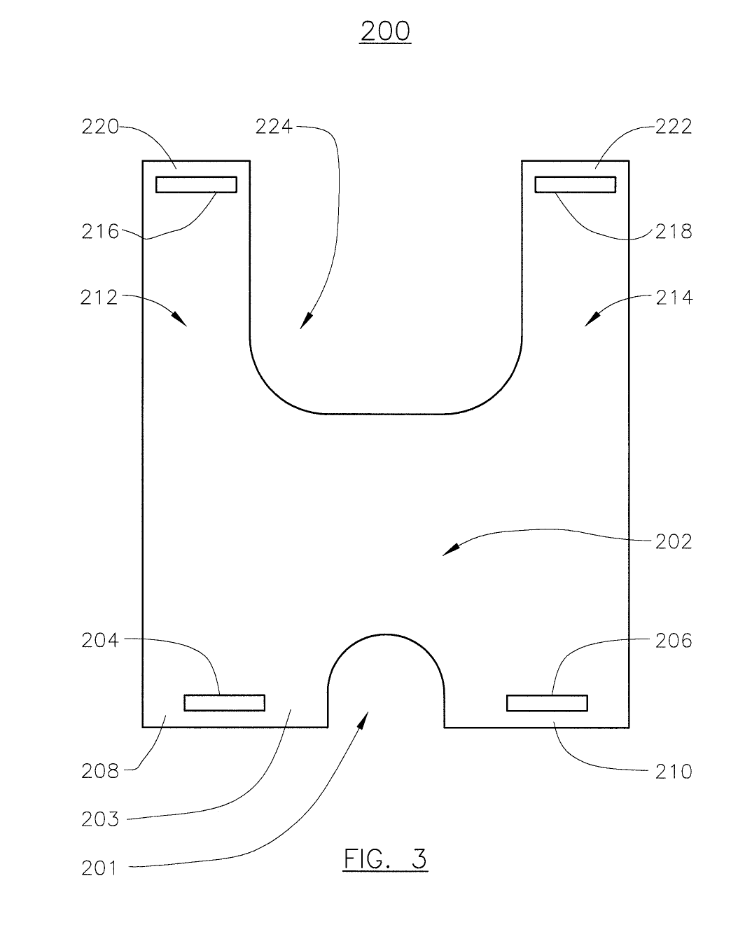

FIG. 3 illustrates a cape or garment 200 configured in accordance with another embodiment of the present invention. The garment 200 includes a cut-out 201 on an upper end 203 of a main portion 202 of the garment 200 for draping around the neck of an automobile driver. Connectors 204,206 on upper tabs 208,210 of the upper end 203 of the garment function to attach the upper end 203 to the back shoulders of an automobile driver or the back of a seat of an automobile driver.

Arm extensions 212,214 extend from the main portion 202 of the garment 200. The arm extensions 212,214 preferably are formed from the same piece of material as the main portion 202. Wrist connectors 216,218 are attached to the distal ends 220,222 of the arm extensions 212,214. The embodiment shown in FIG. 3 provides an opening 224 in the garment 200 for the situation wherein an automobile driver already is wearing protecting clothing to cover his or her laps and knees.

While specific embodiments have been shown and described to point out fundamental and novel features of the invention as applied to the preferred embodiments, it will be understood that various omissions and substitutions and changes of the form and details of the apparatus illustrated and in the operation may be done by those skilled in the art, without departing from the spirit of the invention.

1. An apparatus for protecting a driver of an automobile from harmful ultraviolet rays of the sun, comprising:
a sheet of material having an ultraviolet protection factor (UPF) of at least ten, said sheet of material comprising:
a main portion having an upper end and a lower end, wherein the upper end includes a neck opening sized to receive a neck of an automobile driver, said main portion sized to drape over shoulders and front torso of an automobile driver;
a first arm extension portion extending from the main portion sized to drape over one arm of an automobile driver;
a second arm extension portion extending from the main portion sized to drape over a second arm of an automobile driver;
a first wrist connector on a first distal end of the first arm extension for positioning the first distal end around a wrist of an automobile driver; and
a second wrist connector on a second distal end of the second arm extension for positioning the second distal end around another wrist of an automobile driver.

2. The apparatus of claim 1, further comprising:
a lap extension for covering knees of an automobile driver connected to the lower end of the main portion of the sheet of material.

3. The apparatus of claim 2, further comprising:
a lap extension connector for connecting the lap extension to the lower end of the main section of the sheet of material.

4. The apparatus of claim 2, wherein the lap extension has a UPF greater than 10.

5. The apparatus of claim 1, wherein the first and second wrist connector include buttons.

6. The apparatus of claim 1, wherein the first and second wrist connectors each include a wire.

7. The apparatus of claim 1, wherein the first and second wrist connectors each include bendable metal band.

8. The apparatus of claim 1, wherein the first and second wrist connectors each include Velcro®.

9. The apparatus of claim 1, wherein the sheet of material has a UPF greater than 30.

10. A method of protecting a driver of an automobile from harmful ultraviolet rays of the sun, comprising the steps of:
providing a sheet of material having an ultraviolet protection factor (UPF) of at least ten, said sheet of material comprising:
a main portion having an upper end and a lower end, wherein the upper end includes a neck opening sized to receive a neck of an automobile driver, said main portion sized to drape over shoulders and front torso of an automobile driver;
a first arm extension portion extending from the main portion sized to drape over one arm of an automobile driver;
a second arm extension portion extending from the main portion sized to drape over a second arm of an automobile driver;
a first wrist connector on a first distal end of the first arm extension for positioning the first distal end around a wrist of an automobile driver;
a second wrist connector on a second distal end of the second arm extension for positioning the second distal end around another wrist of an automobile driver;
a shoulder connector on the upper end of the main portion for attached the upper end of the main portion to the shoulders of an automobile driver;
draping the sheet of material over the shoulders and torso of the automobile driver;
attaching the first and second distal ends of the arm extensions to the wrists of an automobile driver using the first and second wrist connectors; and
attaching the upper portion of the main portion to the shoulders of an automobile driver using the shoulder connector.
